(19) United States
(12) Patent Application Publication
(10) Pub. No.: US 2015/0232062 A1
(43) Pub. Date: Aug. 20, 2015

(54) BELT REEL

(71) Applicant: TRW Automotive GmbH, Alfdorf (DE)

(72) Inventor: Bernhard Scheuermann, Erkrath (DE)

(21) Appl. No.: 14/422,370

(22) PCT Filed: Aug. 1, 2013
(86) PCT No.: PCT/EP2013/002286

§ 371 Date: Feb. 19, 2015

(30) Foreign Application Priority Data
Aug. 23, 2012 (DE) 10 2012 016 614.1

(51) Int. Cl. B60R 22/34

(52) U.S. Cl. CPC B60R 22/34

(57) ABSTRACT

It is provided in a belt reel (10) for a belt retractor (12) in a vehicle comprising a substantially cylindrical reel body (14) onto which a webbing (36) can be wound and comprising two flanges (16, 18) connected to the axial end faces (20, 22) of the reel body (14) to be rotationally fixed to the latter that the reel body (14) is made of extrusion material and the flanges (16, 18) are molded parts, especially made of plastic material, which are connected to the reel body (14) by form fit and/or adhesive bonding.

### RELATED APPLICATIONS

This application corresponding to PCT/EP2013/002286, filed Aug. 1, 2013, which claims the benefit of German Application No, 10 2012 016 614.1, filed Aug. 23, 2012, the subject matter, of which are incorporated herein by reference In their entirety.

### BACKGROUND OF THE INVENTION

The invention relates to a belt reel for a belt retractor in a vehicle comprising a substantially cylindrical reel body onto which belt webbing can be wound as well as comprising two flanges which are connected to the axial end faces of the reel body to be rotationally fixed to the latter.

Belt reels serve for winding up the webbing of a seat belt in a vehicle. The webbing is wound onto a cylindrical reel body with a flange being provided at each of the axial end face thereof. The belt reel is pivoted via said flanges within the frame of a belt retractor. In addition, further means of the belt retractor, such as a winding mechanism or a belt tensioner, can act on said flanges.

Usually such belt reels are manufactured in one piece by extrusion molding. The manufacture of such belt reel is very complicated, however, as very high precision is required during fabrication. The belt reel moreover has to be sufficiently stable so as to be capable of absorbing forces occurring In a case of restraint. Furthermore, belt reels frequently includes structures for force transmission at the flanges, for example toothed profiles or projections which form undercuts, whereby the one-piece manufacture by extrusion molding becomes more complicated. Therefore the belt reel Is one of the most expensive parts of a belt retractor.

### SUMMARY OF THE INVENTION

It is the object of the invention to provide a belt reel for a belt retractor in a vehicle which can be manufactured more easily and thus more cost-effective but exhibits the required precisions and stabilities.

For achieving the object it Is provided in a belt reel for a belt refractor In a vehicle comprising a substantially cylindrical reel body onto which webbing can be wound as well as comprising two flanges connected on the axial end faces of the reel body to be rotationally fixed to the same that the reel body is made of extrusion material and the flanges are melded parts, especially made of plastic material, which are connected to the reel body by form fit and/or adhesive bonding.

The basic idea of the invention consists in composing the belt reel of Plural single parts each of which can be manufactured separately. This permits individual adaptation of the flanges and the real body to the respective loads, for example by a specific selection of the material used. The reel body can be made of an extruded aluminum profile, an extruded steel profile, a fiber-reinforced plastic profile or any other material which is suited for absorbing high loads. Such extrusion material offers the advantage that it can be manufactured at low cost in any length and can be cut to the desired length of the reel body.

The flanges can be manufactured of a material, for example plastic material, which can be easily manufactured by injection molding. This also permits a reduction of weight of the belt reel. Since the flanges are separately manufactured, the manufacture thereof is moreover by far simpler, because a mold for one single flange includes by far fewer undercuts and thus fewer or even no sliding cores are required in the mold, The manufacture of the flanges of plastic material further offers the advantage that the bearing of the belt reel can equally be made of plastic material, whereby the friction of the belt reel can be reduced.

The flanges of the belt reel can simply be made, for example, of a cast part, i.e. the flanges are fabricated separately in a mold which enables a more cost-effective manufacture of the molded parts.

It is especially imaginable that the molded parts are injection molded parts.

In order to connect the reel body to be rotationally fixed to the flanges, preferably fastening elements interacting at the reel body and at the flanges are provided by which a torque-tight connection is possible. The connection can be made, for example, by projections or recesses in the components which form a tooth system so that the reel body and the flanges can be easily put together and a positive connection is made.

In order to reduce the weight of the belt reel, the reel body preferably includes cavities extending in the axial direction through the entire reel body. They can be easily manufactured in the case of an extruded profile.

The cavities moreover can be used as a fastening element In such embodiment retaining elements engaging in said cavities and fastening the flanges in a rotationally fixed manner on the reel body are provided on the flanges. In this way a simple rotationally fixed connection of the flanges and the reel body is possible. No additional fastening elements are required on the reel body.

In order to fasten the webbing on the reel body and thus on the heft reel an axial slit extending from the shell surface into the interior of the reel body and opening into a duct Inside the reel body is preferably provided in the shell surface of the reel body. The duct forms an undercut in the radial direction. The webbing can be inserted in the duct with a thickened end and can be guided out of the reel body through the slit. Since the thickened end cannot slip out of the duct the webbing is retained under tensile strength on the reel body and thus on the belt reel. For example, the webbing is inserted in the axial direction into the slit and, resp., the duct before the belt reel is assembled. Subsequently, the flanges are attached and hence the webbing is fixed in the reel body.

So as to ensure ideal load transmission the slit preferably extends radially inwardly and the duct is located substantially on the central axis of the reel body.

For being able to thread the webbing as easily as possible onto the reel body the slit extends at least up to an axial end face so that the webbing can be pushed onto the reel body in the axial direction.

### BRIEF DESCRIPTION OF THE DRAWINGS

Further advantages and features of the invention can be inferred from the following description in conjunction with the enclosed drawings, in which;

FIG. 1 shows an exploded view of a belt reel according to the invention,

FIG. 2 shows a first perspective view of the belt reel of FIG. 1,

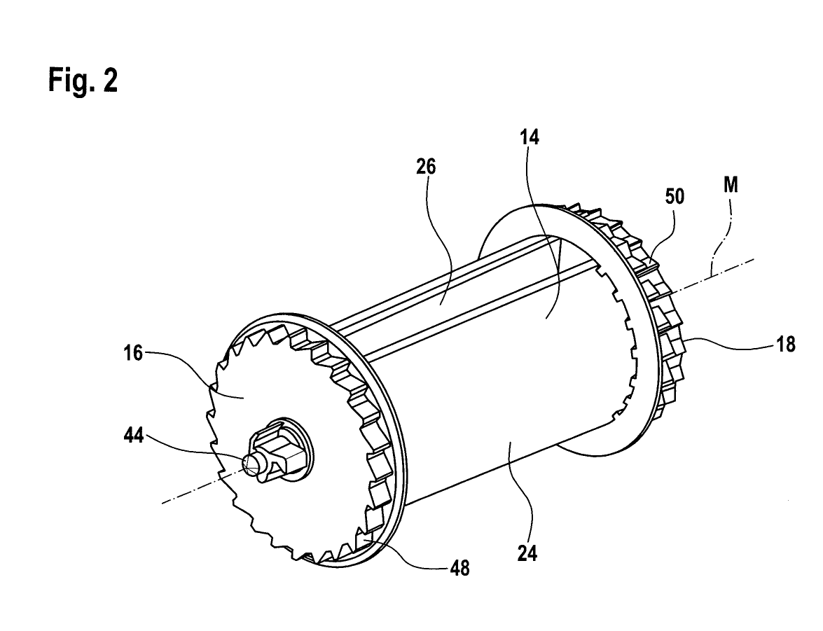

FIG. 3 shows a second perspective view of the belt reel of FIG. 1,

FIG. 4 shows a perspective view of the belt reel of FIG. 1 in an interim assembly state,

FIG. 5 shows a perspective view of the belt reel of FIG. 1 in a final assembly state, and

FIG. 6 shows the belt reel of FIG. 1 in a broken view in a belt retractor.

### DESCRIPTION

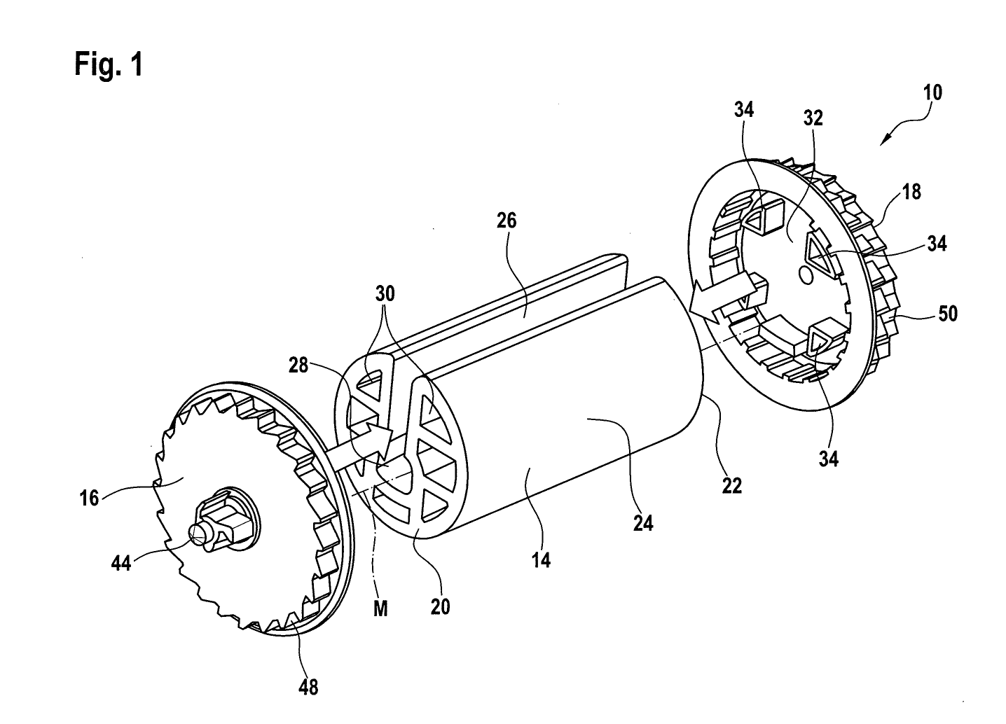

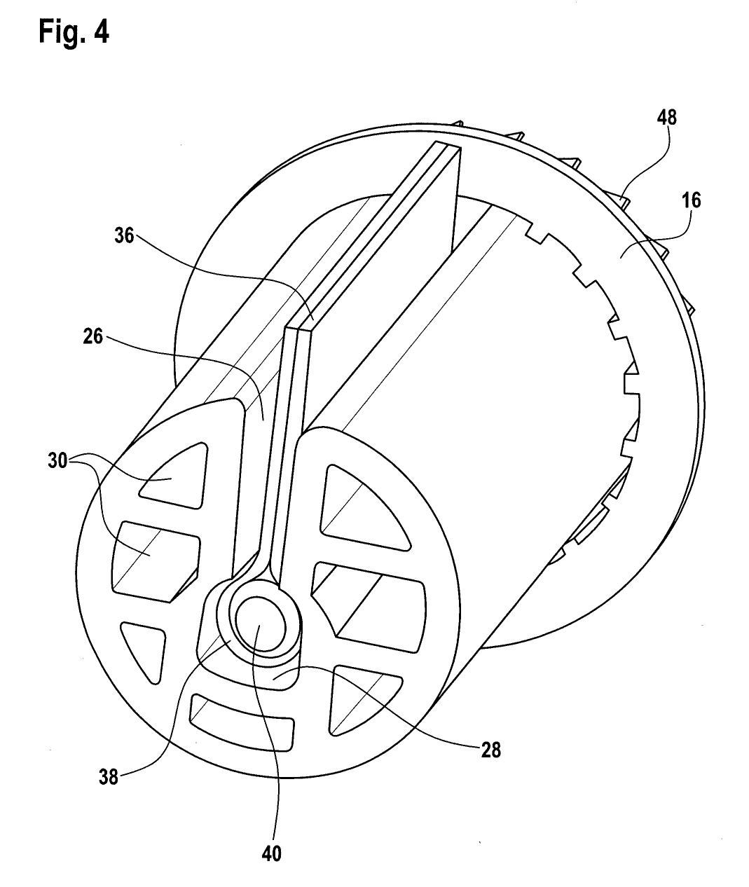

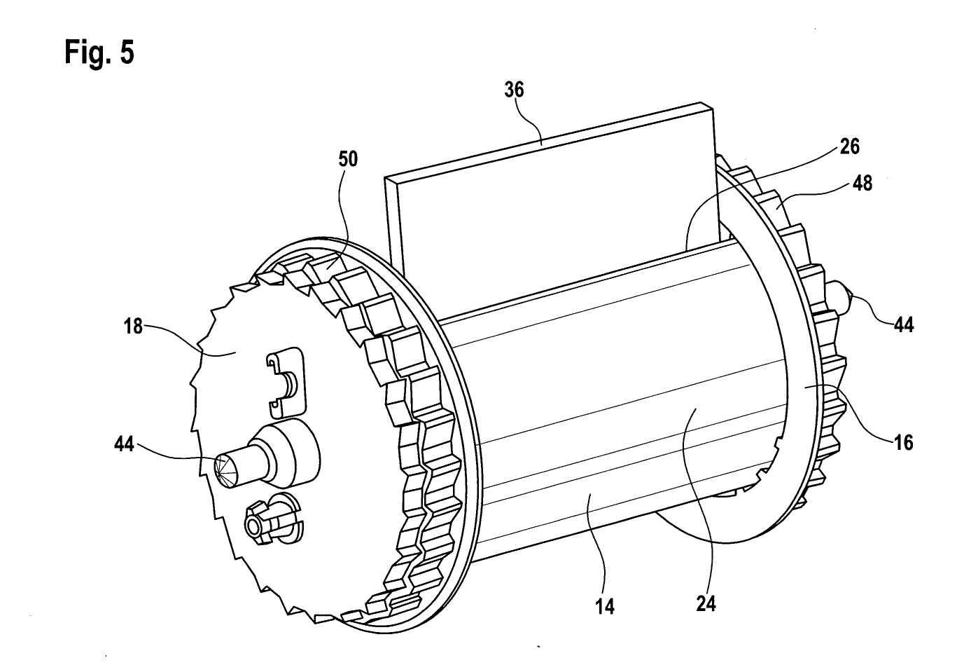

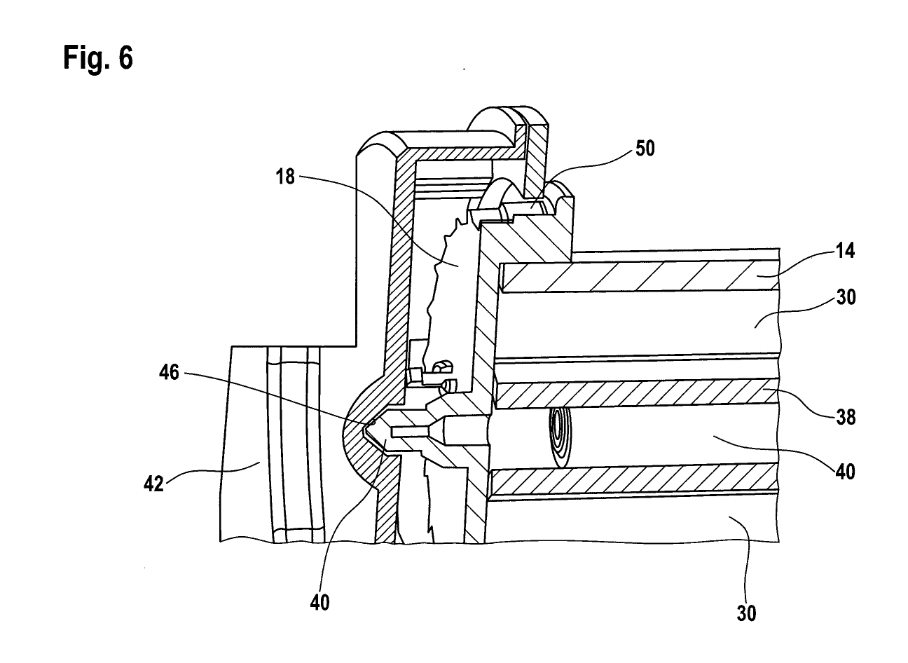

In FIG. 1 a belt reel 10 is illustrated for a belt retractor 12 shown In cutouts in FIG. 6. The belt reel 10 includes a substantially cylindrical reel body 14 comprising a central axis M onto which a webbing 36 (see also FIGS. 4 and 5) of a seat belt can be wound. Flanges 16, 18 via which the belt reel 10 can be supported in a frame 42 of the belt retractor are provided on the axial end faces 20, 22 of the reel body 14.

As is evident from FIG. 1, on the shell surface 24 of the reel body 14 a slit 26 extending in the axial direction from the first axial end face 20 to the second axial end face 22 is provided. In the interior of the reel said slit 26 opens into an extended duct 28 which in the embodiment illustrated here extends approximately on the central axis M of the reel body 14, in the reel body 14 moreover plural cavities 30 are provided which extend In the axial direction through the entire reel body.

The reel body 14 is made of extrusion material, for example of an extruded aluminum or steel profile. Alternatively, for the purpose of weight reduction also a fiber-reinforced extruded profile can be employed. Said extruded profile can be supplied In the form of a long rod and can be cut to the desired length of the reel body 14. The slit 26, the duct 28 as well as the cavities 30 can be easily manufactured In the case of such extruded profile.

The flanges 16, 18 are molded parts made of plastic material. Preferably an injection molding method is employed for this purpose.

The flanges include a recess 32 corresponding to the outer diameter of the reel body 14 on the side facing the reel body 14, In this recess plural retaining elements 34 are provided each being dimensioned and positioned so that they can be inserted in the cavities 30 of the reel body 14.

For assembly the flanges 16, 18 are attached to the reel body 14 in the axial direction and are connected to be rotationally fixed to the reel body 14 by the retaining elements 34 engaging in the cavities 30.

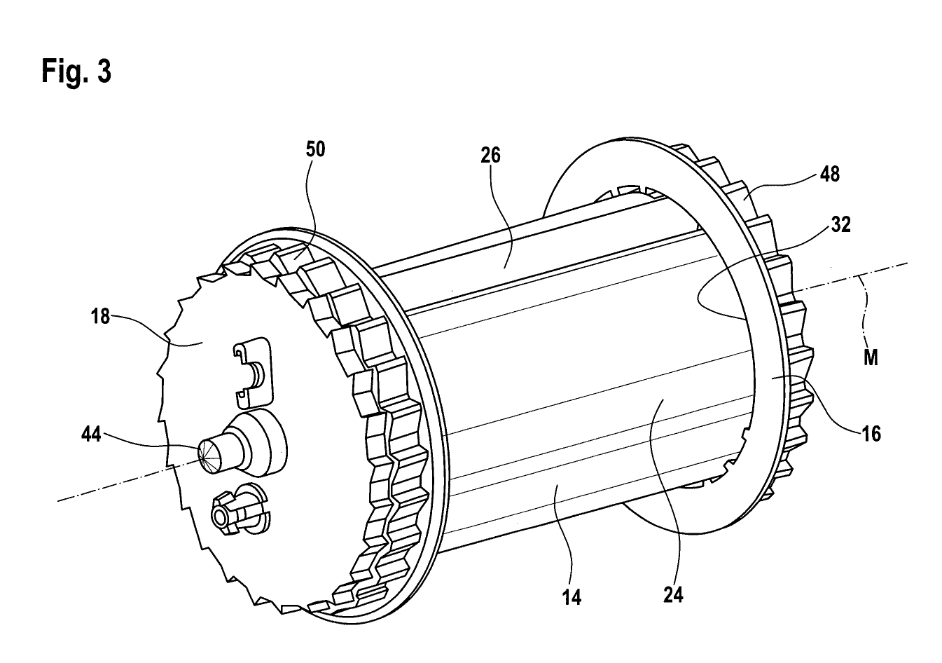

For manufacturing the belt reel 10 for example a first flange 16 can be attached onto the first axial end face 20 (FIG. 3). Then a webbing 36 is introduced from the second axial end face 22 in the axial direction into the slit 26 or the duct 28, respectively. Subsequently the second flange 18 is attached onto the second axial end face 22 (FIG. 4).

A loop 38 into which a bolt 40 can be inserted is provided at the end of the webbing 36. With the bolt being inserted, the diameter of the webbing 36 is larger than the width of the slit 26. Thus the webbing 36 cannot be pulled out of the reel body 14 in the radial direction. In the axial direction fixation is effectuated by the attached flanges 16, 18.

After being assembled, the belt reel 10 is inserted in the frame 42 of the belt retractor 12. For this purpose projecting pins 44 which are adapted to engage in an appropriately configured bearing 46 on the frame 42 are provided at the flanges 16, 18. Furthermore, a toothed profile 48, 50 into which a tensioning or blocking means fixed to the frame can engage is provided at the periphery of the flanges.

The flanges 16, 18 can additionally be connected to the reel body 14 by adhesive bonding, for example by gluing or ultrasonic welding, so that they are safely secured to each other.

The bearings 46 of the belt reel 10 may as well be configured in such way, for example, that a restricted displacement of the belt reel 10 within the frame 42 is possible so that a blocking means fixed to the frame can engage in the toothed profile 48, 50 on the outside of the flanges 16, 18.

1-10. (canceled)

11. A belt reel (10) for a belt retractor in a vehicle comprising a substantially cylindrical reel body (14) onto which a webbing (36) can be wound as well as comprising two flanges (16, 18) which are connected on the axial end faces (20, 22) of the reel body (14) to be rotationally fixed to the latter,
wherein the reel body (14) is made of extrusion material and the flanges (16, 18) are molded pasts, especially made of plastic material, which are connected to the reel body (14) by form fit and/or adhesive bonding,
and wherein cavities (30) extending in the axial direction through the entire reel body (14) are provided in the reel body (14).

12. The belt reel according to claim 11, wherein the flanges (16, 18) are castings.

13. The belt reel according to claim 11, wherein the flanges (16, 18) are injection molded parts.

14. The bell reel according to claim 11, wherein fastening elements interacting on the reel body (14) and on the flanges (16, 18) are provided by which a torque-fight connection of the flanges (16, 18) and the reel body (14) is produced.

15. The belt reel according to claim 11, wherein the flanges (16, 18) Include retaining elements (34) engaging In the cavities (30) and fixing the flanges (16, 18) on the reel body (14) in a rotationally tight manner.

16. The belt reel according to claim 11, wherein on the shell surface (24) of the reel body (14) an axial slit (26) is provided which extends from the shell surface (24) into the inferior of the reel body (14) and opens into a duct (28) inside the reel body (14).

17. The belt reel according to claim 16, wherein the slit (26) extends radially inwardly and the duct (28) is substantially located on the central axis (M) of the reel body (14).

18. The belt reel according to claim 16, wherein the slit (26) extends at least up to an axial end face (20, 22).

19. The belt reel according to claim 11, wherein an axially projecting pin (46) via which the belt reel (10) is supported in a belt retractor (12) is provided on at least one flange (16, 18).
